(19) United States
(12) Patent Application Publication
(10) Pub. No.: US 2016/0100361 A1
(43) Pub. Date: Apr. 7, 2016

(54) COMMUNICATION METHODS AND COMMUNICATION DEVICES

(71) Applicant: Agency for Science, Technology and Research, Singapore (SG)

(72) Inventors: Shoukang ZHENG, Singapore (SG); Zhongding LEI, Singapore (SG)

(73) Assignee: Agency for Science, Technology and Research, Singapore (SG)

(21) Appl. No.: 14/889,731

(22) PCT Filed: May 12, 2014
(86) PCT No.: PCT/SG2014/000209

§ 371 Date: Nov. 6, 2015

(30) Foreign Application Priority Data
May 10, 2013 (SG) 201303655-3
Dec. 31, 2013 (SG) 201309710-0

(51) Int. Cl. H04W 52/02; H04L 12/861

(52) U.S. Cl. CPC H04W 52/0209; H04L 49/90

(57) ABSTRACT

According to various embodiments, a communication method may be provided. The communication method may include at least one of sending a data unit or receiving a data unit. The data unit may include or may be a poll type field indicating one of a plurality of requests from a mobile radio communication device to an access point with respect to at least one of transmission of buffered data from the access point to the mobile radio communication device or a timing of communication between the access point and the mobile radio communication device.

### CROSS-REFERENCE TO RELATED APPLICATIONS

The present application claims the benefit of the Singapore patent application No. 201303655-3 filed on 10 May 2013, the entire contents of which are incorporated herein by reference for all purposes. The present application furthermore claims the benefit of the Singapore patent application No. 201309710-0 filed on 31 Dec. 2013, the entire contents of which are incorporated herein by reference for all purposes.

### TECHNICAL FIELD

Embodiments relate generally to communication methods and communication devices.

### BACKGROUND

In wireless communication, a mobile station (which may for example be referred to as a station or STA) may communicate with an access point (AP). A large number of STAs may be provided, so that efficient data communication may be desired.

### SUMMARY

According to various embodiments, a communication method may be provided. The communication method may include at least one of sending a data unit or receiving a data unit. The data unit may include or may be a poll type field indicating one of a plurality of requests from a mobile radio communication device to an access point with respect to at least one of transmission of buffered data from the access point to the mobile radio communication device or a timing of communication between the access point and the mobile radio communication device.

According to various embodiments, a communication device may be provided. The communication device may include a data processing circuit configured to least one of send a data unit or receive a data unit. The data unit may include a poll type field indicating one of a plurality of requests from a mobile radio communication device to an access point with respect to at least one of transmission of buffered data from the access point to the mobile radio communication device or a timing of communication between the access point and the mobile radio communication device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a mobile radio communication system according to various embodiments;

FIG. 1B shows a flow diagram illustrating a communication method according to various embodiments;

FIG. 1C shows a communication device according to various embodiments;

FIG. 2 shows a frame control field according to various embodiments and according to a first option;

FIG. 3 shows a frame control field according to various embodiments and according to a second option;

FIG. 4 shows an illustration of a PS-Poll frame transmission with Poll Type=0 according to various embodiments;

FIG. 5 shows an illustration of a PS-Poll frame transmission with Poll Type=1 according to various embodiments;

FIG. 6 shows an illustration of a PS-Poll frame transmission with Poll Type=2, for example for a TWT STA, according to various embodiments;

FIG. 7 shows an illustration of a PS-Poll frame transmission with Poll Type=2, for example for a non-TWT STA, according to various embodiments; and

FIG. 8, FIG. 9A, and FIG. 9B show illustrations of PS-Poll frame transmissions with Poll Type=3 according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the communication device as described in this description may include a memory which is for example used in the processing carried out in the communication device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

The IEEE (Institute of Electrical and Electronics Engineers) 802.11ah new standard may be used for Smart Grid, sensor network and 3G data offloading. This amendment may enable the IEEE 802.11 standard to operate on frequency bands below 1 GHz. This may be different from the legacy IEEE 802.11 standard, which is defined for a wider channel such as 20 MHz or more. The IEEE 802.11ah may operate on a narrower channel such as 1, 2, 4, 8 and 16 MHz, different from the legacy IEEE 802.11 standard. The data rate may be as low as 150 kbps.

The Smart Grid applications, which may be among the various application supported by the IEEE 802.11ah standard, may desire that a single Access Point (AP) is able to support a large number of stations (STAs) e.g. 6000 STAs. The sensor network may prefer a more efficient MAC (medium access control) operation and low power consumption. To solve the issues, various schemes may be provided to enhance the IEEE 802.11 technology in channel accessing, TIM Bitmap encoding, header compression and power saving. According to various embodiments, schemes for Poll Type may be provided.

To support a large number of STAs by a single AP may bring new challenges to the existing IEEE 802.11 technology. To solve these challenge issues, various schemes that enhance the IEEE 802.11 technology in channel accessing, TIM Bitmap encoding, header compression and power saving etc. may be provided. According to various embodiments, various methods may be provided that further improve the design of 802.11ah communication protocols in various aspects. According to various embodiments, the following schemes may be provided:
Poll type and active polling; and
Listen Interval for TWT (target wakeup time).

According to various aspects of this disclosure, NDP (null data packet) Modified ACK (acknowledgement), Modified NDP ACK, and Modified Short ACK may be the same.

To assist stations with power saving, Access Points (APs) may be designed to buffer frames for a station when that station is in power save mode and to transmit them later to the station when the AP knows the station will listen. When a station is in power save mode, it can turn off its transmitter and receiver to preserve energy. It takes less power for a station to turn its receiver on to listen to frames than to turn it its transmitter on to transmit frames.

AP may indicate the buffered frame status in the TIM element of the broadcast message e.g. beacon frame. Once the STA wakes up, if it receives the broadcast message e.g. beacon frame, it can send Power Save Poll (PS-Poll) to its AP so that the AP can deliver the buffered frame to the polling STA. If the STA is allowed to poll the AP without listening to the broadcast message e.g. beacon frame, the STA may save more power. In some cases, a long sleep STA may not synchronize with the AP. It may choose to poll its AP after wake up for the timing information so that it can resynchronize with the AP, without keeping listening to the channel. Alternatively, if there could be some critical change e.g. modification of the EDCA parameters at the AP, the long sleep STA may poll its AP to acquire the change sequence so that it can detect whether such change occurs.

According to various embodiments, communication protocol designs for 802.11ah may be provided.

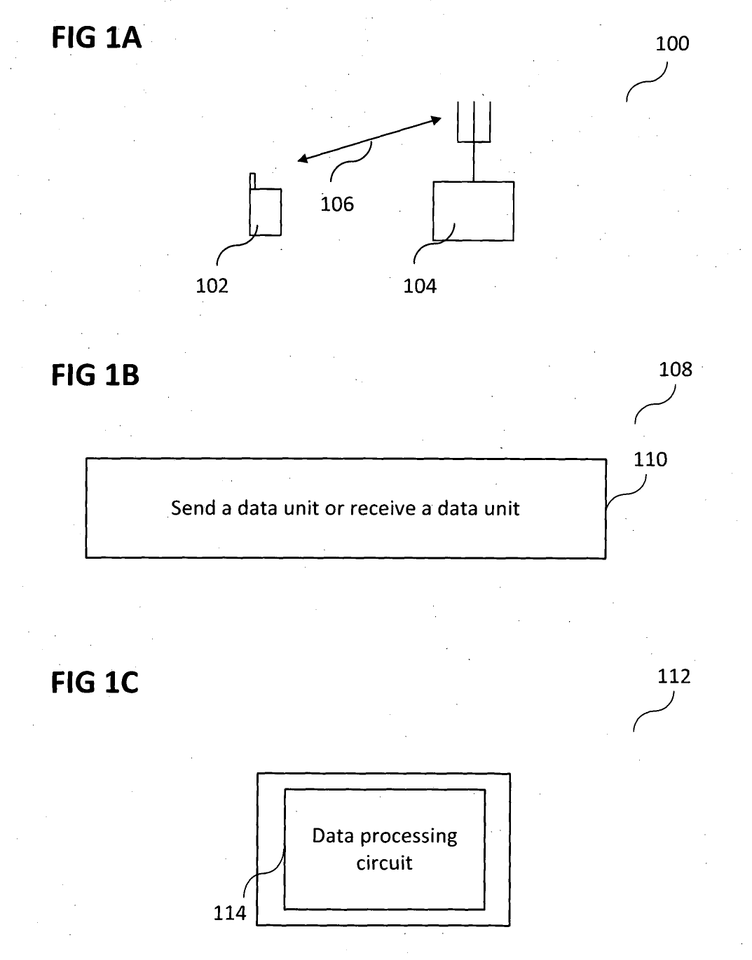

FIG. 1A shows a mobile radio communication system 100 according to various embodiments. A mobile radio communication terminal 102 (for example a mobile station, for example referred to herein by STA) may communicate with an access point 104, like indicated by arrow 106. The access point 104 (which may be referred to herein as AP) may indicate to the mobile station 102 when it has data for the station 102.

FIG. 1B shows a flow diagram 108 illustrating a communication method according to various embodiments. In 110, a data unit may be sent or received. The data unit may include a poll type field indicating one of a plurality of requests from a mobile radio communication device to an access point with respect to at least one of transmission of buffered data from the access point to the mobile radio communication device or a timing of communication between the access point and the mobile radio communication device.

In other words, data that indicates which request selected from a plurality of candidate requests a mobile radio communication device sends to an access point.

The request could be with respect to acquiring a duration to TBTT i.e. synchronization with AP (Poll Type=2), acquiring next Target Wake Time (Poll Type=2), acquiring the information of beacon change sequence (active polling, Poll Type=1). It is to be noted that the polling with Poll Type=1 & 2 may not result in the transmission of buffered data (e.g. the STA may just wake up to receive the beacon only).

The Change Sequence is 1 octet in length and is defined as an unsigned integer initialized to 0, that increments when a critical update occurs to any of elements inside Beacon frame.

The S1G AP may increase the value (modulo 256) of the Change Sequence field in the next transmitted S1G Beacon frame(s) when a critical update occurs to any of the elements inside the S1G Beacon frame. The following events shall classify as a critical update:
a) Inclusion of an Extended Channel Switch Announcement;
b) Modification of the EDCA parameters;
c) Modification of the S1G Operation element.

An S1G AP can classify other changes in the S1G Beacon frame as critical updates.

According to various embodiments, the data unit may include or may be or may be included in a power save poll.

According to various embodiments, the plurality of requests may include a request for a buffered frame without rescheduling of an awake/doze cycle (for example a request for a buffered frame without a request to reschedule of an awake/doze cycle, for example like will be described with reference to Table 1 below). It will be understood that an awake/doze cycle may be a pattern or a timing or a series of points in time according to which or at which the mobile radio communication device changes or defines its operation state, for example between or to an awake state or a sleep state.

According to various embodiments, the plurality of requests may include a request for a change of a sequence, for example a beacon change sequence, and/or and a timestamp information. The requested info may be a e.g. 2-byte beacon sequence number which changes monotonically before rollover.

According to various embodiments, the plurality of requests may include a request for a timing information.

According to various embodiments, the timing information may include or may be at least one of a duration to a TBTT or next TWT.

According to various embodiments, the plurality of requests may include a request for a deferred service period or a duration to a service period to reschedule awake/doze cycle (for example with Poll Type bits set to 11 in accordance with Table 1, like will be described below).

According to various embodiments, the plurality of requests may include a request to reschedule an awake/doze cycle for a downlink transmission.

According to various embodiments, the plurality of requests may include a request to reschedule an awake/doze cycle for an uplink transmission.

In a case of Poll Type=2 for request for a duration for a TBTT (Target Beacon Transmission Time), the request is to request to schedule neither UPLINK transmission nor DOWNLINK transmission. Instead, the AP may send a duration to a Target Beacon Transmission Time so that the requesting STA can wake up after the indicated duration (starting from the end of the response frame to the eliciting message with the Poll Type=2) expires. It is to be noted that the beacon usually is not rescheduled.

According to various embodiments, the plurality of requests may include a request according to Table 1, which will be described below.

According to various embodiments, the sending or receiving of the data unit may be sending the data unit from a mobile radio communication device to an access point.

According to various embodiments, the mobile radio communication device may sleep or awakes in accordance with the data unit the mobile radio communication device sends.

According to various embodiments, the mobile radio communication device may sleep or awake in accordance with the received response to the data unit the mobile radio communication device sends.

According to various embodiments, the sending or receiving of the data unit may be receiving the data unit in an access point from a mobile radio communication device.

According to various embodiments, the access point may transmit buffered data to the mobile radio communication device in accordance with the data unit received by the access point.

FIG. 1C shows a communication device 112 according to various embodiments. The communication device 112 may include a data processing circuit 114 configured to least one of send a data unit or receive a data unit. The data unit may include a poll type field indicating one of a plurality of requests from a mobile radio communication device to an access point with respect to at least one of transmission of buffered data from the access point to the mobile radio communication device or a timing of communication between the access point and the mobile radio communication device.

According to various embodiments, the data unit may include or may be or may be included in a power save poll.

According to various embodiments, the plurality of requests may include a request for a buffered frame without rescheduling of an awake/doze cycle (for example a request for a buffered frame without a request to reschedule of an awake/doze cycle).

According to various embodiments, the plurality of requests may include a request for a change of a sequence and/or a timestamp information.

According to various embodiments, the plurality of requests may include a request for a timing information.

According to various embodiments, the timing information may include or may be at least one of a duration to a TBTT or next TWT.

According to various embodiments, the plurality of requests may include a request for a deferred service period or a duration to a service period to reschedule awake/doze cycle (for example with Poll Type bits set to 11 in accordance with Table 1, like will be described below).

According to various embodiments, the plurality of requests may include a request to reschedule an awake/doze cycle for a downlink transmission.

According to various embodiments, the plurality of requests may include a request to reschedule an awake/doze cycle for an uplink transmission.

According to various embodiments, the plurality of requests may include a request according to Table 1, which will be described below.

According to various embodiments, the communication device may include or may be or may be included in a mobile radio communication device. The data processing circuit of the radio communication device may include or may be or may be included in a transmitter configured to send the data unit to an access point.

According to various embodiments, the mobile radio communication device may be configured to sleep or awake in accordance with the data unit the mobile radio communication device sends.

According to various embodiments, the mobile radio communication device may be configured to sleep or awake in accordance with the received response to the data unit the mobile radio communication device sends.

According to various embodiments, the communication device may include or may be or may be included in an access point. The data processing circuit of the access point may include or may be or may be included in a receiver configured to receive the data unit in an access point from a mobile radio communication device.

According to various embodiments, the access point may be configured to transmit buffered data to the mobile radio communication device in accordance with the data unit received by the access point.

In the following, poll type and active polling will be described.

In the following, two options for a poll type embodiment according to various embodiments will be described. A STA may use Poll Type bits to indicate its request on the information that it solicits from its AP. TWT may be the Target Wake Time. The polling message may be either the baseline PS-Poll (power save poll) or a new control frame defined as follows.

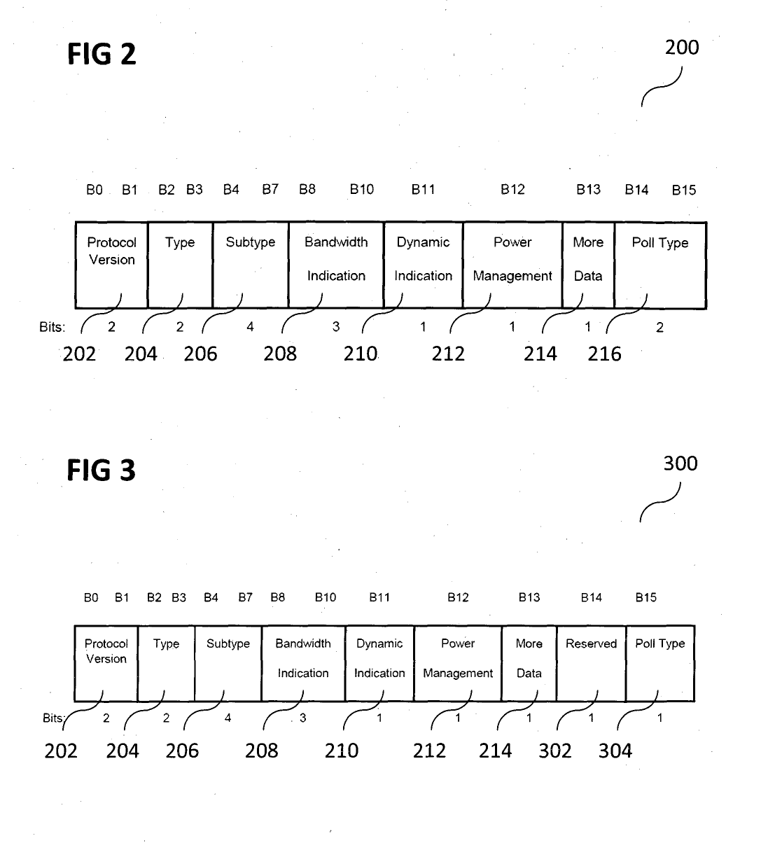

FIG. 2 shows a frame control (FC) field 200 according to various embodiments and according to a first option (which may be referred to as “Option 1”), when the value of a Type subfield 204 (for example having a size of 2 bits) is equal to 1 and the value of a Subtype subfield 206 (for example having a size of 4 bits is equal to 10 (for example assuming the PS-Poll in the 802.11 standard allows a change) or a reserved value, and the remaining subfields within the Frame Control field 200 of S1G control frames may be the following: Bandwidth Indication 208, Dynamic Indication 210, Power Management 212, More Data 214, and Poll Type 216. A protocol version subfield 202 may also be provided. In FIG. 2, the number of bits in each subfield, and the names of the bits are described. For example, the type subfield 204 may include 2 bits (B2 and B3).

SIG (or S1G) may mean SIGNAL field of PPDU (physical protocol data unit).

S1G PPDU (i.e. the PPDU format for 11ah) may include:
STF Short Training field;
LTF Long Training field;
SIG SIGNAL field;
SIG-A Signal A field;
D-STF Short Training field for data;
D-LTF Long Training field for data;
SIG-B Signal B field; and
Data.

The Data field may carry the PSDU(s) (Physical layer Service Data Unit).

The null data packet (NDP) may include:
STF Short Training field;
LTF Long Training field; and
SIG SIGNAL field.

The null data packet (NDP) frame has no Data field.

One of PPDU formats that includes PSDU could be:
STF Short Training field;
LTF Long Training field;
SIG SIGNAL field: and
Data.

The Data field may carry the PSDU(s).

The Poll Type (sub)field 216 may be 2 bits in length. The Poll Type bit 0 may be bit 14 and the Poll Type bit 1 may be bit 15. The following indication may only be valid when Power Management (sub)field 212 is set to 1. Otherwise, when Power Management (sub)field 212 is set to 0, the Poll Type bits may be reserved. Table 1 illustrates the Poll Type description for an embodiment.

TABLE 1
Poll Type.

| Poll Type | |
|---|---|
| value b14 b15 | Description |
| 00 | Requesting a buffered frame without rescheduling awake/ |
| | doze cycle (or without a request to reschedule awake/ |
| | doze cycle) |
| 01 | Requesting Change Sequence/Timestamp |
| 10 | Requesting for a duration to a TBTT or Next TWT to |
| | reschedule awake/doze cycle |
| 11 | Requesting for a duration to a service period to |
| | reschedule awake/doze cycle |

According to various embodiments, the low power STA may choose to indicate its request for the resynchronization with the beacon transmission time. After waking up from the doze state, the low power STA may send its polling message immediately without listening for a beacon by setting Poll Type bits to 10 for awake/doze cycle rescheduling. Alternatively, if the STA does not want to go to sleep, it may set Poll Type bit to 00, waiting for receiving the acknowledgement (e.g. ACK/NDP ACK/TACK (TWT acknowledgement)/STACK (short TWT acknowledgement)) or downlink buffered frame from its AP. The STA may choose to set Poll Type bits to 11 for a deferred service period after receiving the response frame from its AP.

According to various embodiments, Poll Type bits may be set as shown in Table 2. According to various embodiments, the low power STA may choose to indicate its request for the downlink transmission time (either a beacon or a buffered frame). After waking up from the doze state, the low power STA may send its polling message immediately without listening for a beacon by setting Poll Type bits to 10 for awake/doze cycle rescheduling. Upon wakeup from the rescheduling, the STA may wait for receiving a beacon or downlink buffered frame from its AP. The STA may choose to set Poll Type bits to 11 for a deferred service period after receiving the response frame from its AP. Once the deferred service period is due, the STA is allowed to transmit the frame to its AP. It will be understood that deferring (or deferred) service period may mean a service period that will be deferred later by a specific length of time. Hence the term “duration” in Table 1 may refer to this “length of time”.

TABLE 2
Poll Type.

| Poll Type | |
|---|---|
| value b14 b15 | Description |
| 00 | Requesting a buffered frame without rescheduling awake/ |
| | doze cycle |
| 01 | Requesting Change Sequence/Timestamp |
| 10 | Requesting for a duration to a TBTT or Next TWT to |
| | reschedule awake/doze cycle for Downlink transmission |
| 11 | Requesting for a duration to a service period to |
| | reschedule awake/doze cycle for uplink transmission |

FIG. 3 shows a frame control (FC) field 300 according to various embodiments and according to a second option (which may be referred to as “Option 2”). Various subfields shown in FIG. 3 may be identical or similar to subfields shown in FIG. 2, so that the same reference signs may be used and duplicate description may be omitted. When the value of the Type subfield 204 is equal to 1 and the value of the Subtype subfield 206 is equal to 10 (assuming that the PS-Poll in the 802.11 standard allows a change) or a reserved value, the remaining subfields within the Frame Control field of S1G control frames may be the following: Bandwidth Indication 208, Dynamic Indication 210, Power Management 212, More Data 214, Protected Frame (or Reserved) 302, and Poll Type 304. In FIG. 3, the number of bits in each subfield, and the names of the bits are described. For example, the type subfield 204 may include 2 bits (B2 and B3).

The Poll Type (sub)field 304 may be 1 bit in length. The Poll Type (sub)field may be bit 15. The Poll Type indication may only be valid when the Power Management (sub)field 212 is set to 1. Otherwise, when the Power Management (sub)field 212 is set to 0, the Poll Type bit 304 may be reserved. Table 3 illustrates the Poll Type description according to various embodiments.

TABLE 3
Poll Type.

| Poll Type | |
|---|---|
| value b15 | Description |
| 0 | Requesting next TWT |
| 1 | Requesting Change Sequence/Timestamp |

In this option, the low power STA may choose to indicate its request for next TWT. After waking up from the doze state, the low power STA may send its polling message immediately without listening for a beacon by setting Poll Type bits to 0 for awake/doze cycle rescheduling.

In the following, the active polling procedure for a STA that can solicit information from AP upon waking up will be described.

Upon waking up and without listening for a beacon, an active polling STA may solicit BSS (Basic Service Set) change sequence and/or current timestamp information from an AP by sending a polling message (e.g. PS-Poll or a new defined control message in this section). In this polling message, it may indicate whether the STA solicits the information of BSS change sequence and/or current timestamp by setting Poll Type bit(s) to 01 for Option 1 or 1 for Option 2, or whether the STA solicits the information of Next TWT or Duration to a TBTT by setting Poll Type bits to 10 for Option 1 or 0 for Option 2.

In response to the received polling message sent by an active polling STA, an AP may send a responding frame such as TACK with the solicited information to the STA immediately. An AP may also send the STA either a NDP ACK that includes a wakeup timer or TACK in which Next TWT field is set to the value of a TBTT, which the AP uses to direct the STA to check the beacon. STA may listen to the beacon when the timer with the value as indicated by Duration field of NDP ACK expires or Next TWT of TACK is due.

Referring back to Table 1, Poll type value 00 may also be referred to as Poll Type 0, Poll type value 01 may also be referred to as Poll Type 1, Poll type value 10 may also be referred to as Poll Type 2, and Poll type value 11 may also be referred to as Poll Type 3. The values of Poll Type subfield in the Frame Control field of PS-Poll may be as shown in the above Table 1.

In the procedure for Poll type set to 0 the active polling STA may solicit the buffered frame (status). If there is no buffered frame, the STA may go to sleep. Otherwise, it will awake till it receives the buffered frame from the AP.

A PS-Poll frame with Poll type set to 1 by an active polling STA may solicit a TACK frame including the information of Change Sequence, (partial) timestamp and buffered frame status.

A PS-Poll frame with Poll type set to 2 by an active polling STA that is a TWT STA may solicit a TACK frame including the information of Change Sequence, (partial) timestamp, buffered frame status and Next TWT.

A PS-Poll frame with Poll type set to 2 by an active polling STA that is not a TWT STA may solicit a NDP ACK frame that may contain the information of buffered frame status and wakeup timer (sleep duration).

A PS-Poll frame with Poll type set to 3 by an active polling STA may solicit a NDP ACK frame that may contain the information of buffered frame status and wakeup timer (sleep duration).

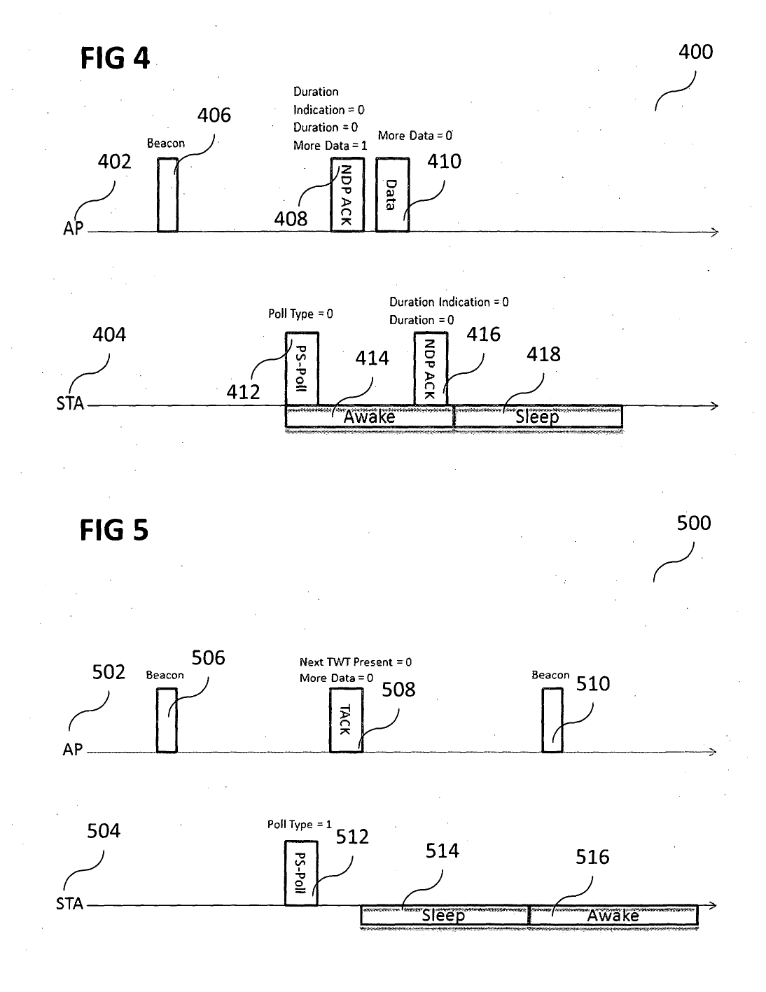

FIG. 4 shows an illustration 400 of a PS-Poll frame transmission with Poll Type=0 according to various embodiments. Processing of an AP 402 and processing of a STA 404 are shown. Time is assumed to enhance from left to right. The AP may send a beacon signal 406.

A non-traffic indication map (non-TIM) mode may be defined as follows: The power save mode for Sub 1 GHz (S1G) non-access point (non-AP) stations (STAs) whereby a S1G non-AP STA need not listen for traffic indication map (TIM) Beacon frame.

A non-traffic indication map (non-TIM) station (STA) may be defined as follows: The Sub 1 GHz (S1G) non-access point (non-AP) station (STA) that entered the non-TIM mode.

A TIM STA may be the STA that should listen to traffic indication map (TIM) Beacon frame.

A target wake time may be defined as follows: A specific time or set of times for individual STAs to wake to exchange frames with other STAs.

A target wake time service period (TWT SP) may be defined as follows: A period of time during which a TWT STA is awake to transmit and/or receive frames.

A target wake time service period start time (TWT SP start time) may be defined as follows: The value of the TSF at the beginning of a TWT SP.

A target wake time STA (TWT STA) may be defined as follows: A STA that has had a requested TWT agreement accepted by another STA and that receives TWT SP start times from that STA.

S1G may refer to sub 1 GHz.

A non-TIM S1G STA may send a (NDP) PS-Poll/trigger frame 412 any time to its associated AP upon waking up without listening to the beacon.

If a non-TIM STA (or a TIM STA) sends a PS-Poll frame 412 with the Poll Type subfield set to 0, it may request a buffered data frame and the AP may send either a data frame 410 or an (NDP) ACK frame 408 as the response. The non-TIM STA (or a TIM STA) may be in the awake state 414 until the response frame from the AP indicates there is no more buffered data for the STA. The STA may send a NDP ACK frame 416, and may then go to sleep state 418.

FIG. 5 shows an illustration 500 of a PS-Poll frame transmission with Poll Type=1 according to various embodiments. Processing of an AP 502 and processing of a STA 504 are shown. Time is assumed to enhance from left to right. The AP may send a beacon signal 506.

If a non-TIM STA (or a TIM STA) sends a PS-Poll frame 512 with the Poll Type subfield set to 1, it requests the information of Change Sequence and Timestamp and the AP may respond with a TACK frame 508 without the Next TWT field. Whether or not the STA will stay awake may depend on the More Data field in the response TACK frame 508. If the More Data field in the TACK frame is set to 1, the STA may stay awake till the buffered frame is delivered from the AP to itself. Otherwise, the STA may go to sleep.

After obtaining the information of beacon change sequence (which may indicate a change) and partial timestamp, the STA may figure out the next TBTT and go to sleep (like shown in 514 of FIG. 5). After wakeup (like shown in 516 of FIG. 5), it may listens to the beacon 510 and updates some of its information from the beacon due to the system information change.

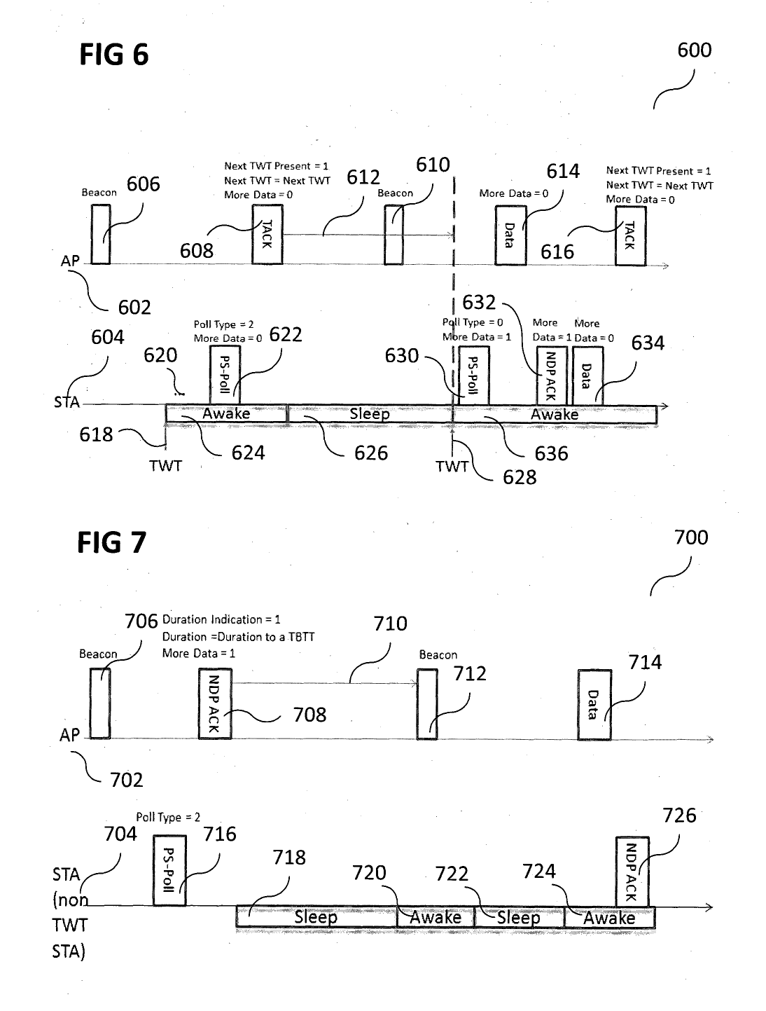

FIG. 6 shows an illustration 600 of a PS-Poll frame transmission with Poll Type=2, for example for a TWT STA, according to various embodiments. Processing of an AP 602 and processing of a STA 604 are shown. Time is assumed to enhance from left to right. The AP may send a beacon signal 606.

After some processing (indicated by dots 620) after a TWT 618, and while in an awake state 624, if a TWT STA sends a PS-Poll frame 622 with the Poll Type subfield set to 2, it requests the Next TWT information and the AP may respond with a TACK frame 608 with a Next TWT field. Whether or not the STA will stay awake may depend on the More Data field in the response TACK frame 608. If the More Data field in the TACK frame 608 is set to 1, the STA may stay awake till the buffered frame is delivered from the AP to itself. Otherwise, the STA may go to sleep.

During its service period after TWT 618, the STA may sends the PS-Poll frame 622 with Poll Type=2 and may receive from the AP the response TACK frame 608 including the information of buffered frame status, next TWT and beacon change sequence and partial timestamp. The STA may go to sleep (like indicated by 626 in FIG. 6) and may wake up (like indicated by awake period 636) at its next TWT time 628. After wakeup, it may transmit a PS-Poll frame 630 with Poll Type=0 (or Poll Type may be set to 2), the AP sends the buffered frame to the STA (for example data 614, which may be acknowledged by the STA with a NDP ACK frame 632). There may also be an uplink buffered frame transmission 634, which may be responded by the AP with a TACK frame 616 to indicate to the STA the next TWT again. Upon there is no more buffered frame for both the AP and the STA, the service period ends. It will be understood that as TACK frame 608 indicated the next TWT to be a time period of 612 away, a beacon 610 sent before the TWT 628 may be not received by the STA.

FIG. 7 shows an illustration 700 of a PS-Poll frame transmission with Poll Type=2, for example for a non-TWT STA, according to various embodiments. Processing of an AP 702 and processing of a STA 704 are shown. Time is assumed to enhance from left to right. The AP may send a beacon signal 706.

If a non-TIM STA (or a TIM STA) that is not a TWT STA sends a PS-Poll frame 716 with the Poll Type subfield set to 2, it requests a Duration to a TBTT and the AP may respond with either a buffered frame or an NDP ACK frame 708 that may include the information of the duration to a TBTT, e.g. by setting the Duration Indication field to 1 and the Duration field to a value of the duration to a TBTT.

After wakeup from sleep state, the STA may send a PS-Poll frame 716 with Poll Type=2 and may receive from the AP the response NDP ACK frame 708 including the information of buffered frame status and wakeup timer (like indicated by arrow 710). The STA may go to sleep (like indicated by sleep state 718) and may wake up (718 (like indicated by awake state 720) to receive the beacon frame 712. During the slot allocated to the STA (before which it may sleep in 722 and be awake in 724), the AP may transmit the buffered frame 714 to the STA, which may acknowledge by an NDP ACK frame 726.

If a non-TIM STA (or a TIM STA) sends a PS-Poll frame with the Poll Type subfield set to 3, it requests a deferred service period for the frame transmission and the AP may respond with either a buffered frame or a NDP ACK frame that may “include the information of the duration to a deferred service period, e.g. by setting the Duration Indication field to 1 and the Duration field to a value of the deferred service period.

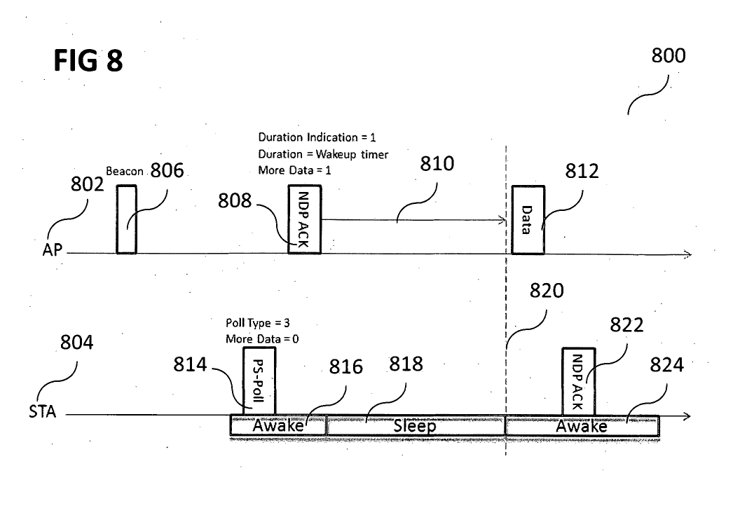

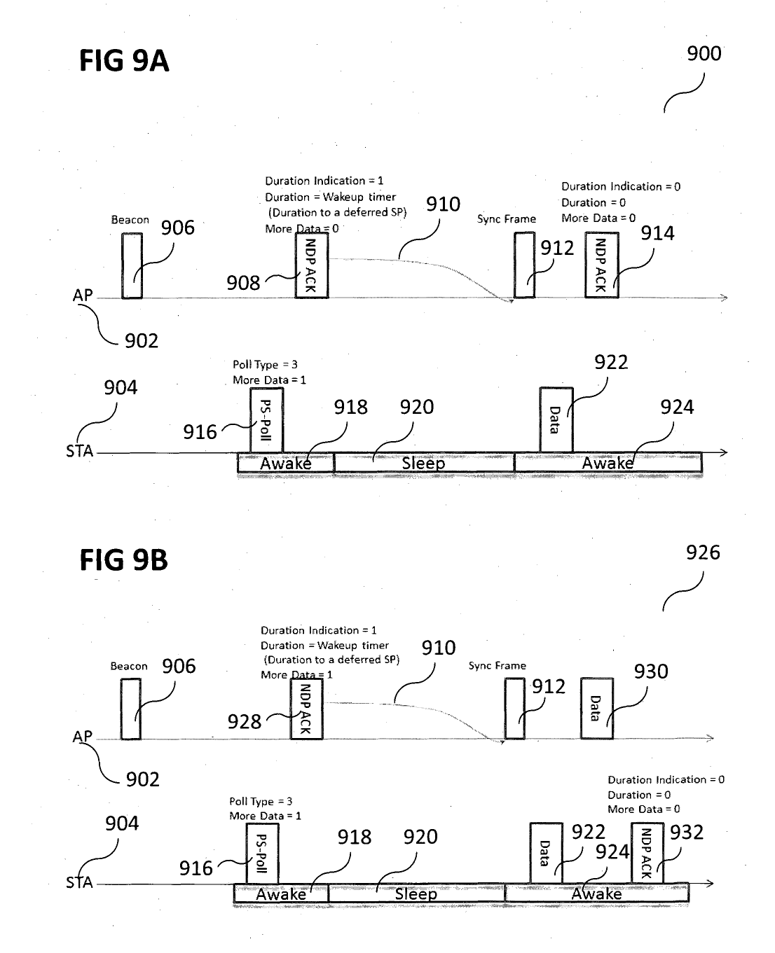

FIG. 8 shows an illustration 800 of a PS-Poll frame transmission with Poll Type=3 (for example for a STA) according to various embodiments. Processing of an AP 802 and processing of a STA 804 are shown. Time is assumed to enhance from left to right. The AP may send a beacon signal 806. After wakeup (like illustrated by awake period 816), the STA may send a PS-Poll frame 814 with Poll Type=3 and may receive from the AP the response NDP ACK frame 808 including the information of buffered frame status and wakeup timer (like indicated by arrow 810). The STA may go to sleep (like indicated by sleep period 818) and may wake up at time 820 (after the wakeup timer expires), like indicated by awake period 824, to receive the buffered frame (for example data 812) form the AP in the deferred service period. The STA may acknowledge the data frame 812 with an NP ACK frame 822.

FIG. 9A shows an illustration 900 of a PS-Poll frame transmission with Poll Type=3 according to various embodiments. Processing of an AP 902 and processing of a STA 904 are shown. Time is assumed to enhance from left to right. The AP may send a beacon signal 906. A STA that has requested time slot protection for a TXOP (transmission opportunity) duration after the expiration of a wakeup timer (like indicated by awake period 918) may transmit to the UL (Uplink)-Synch capable AP a PS-Poll 916 with the Poll Type subfield in the Frame Control field set to 3. An UL-Synch capable AP may respond with an NDP ACK 908 frame to a PS-Poll with Poll Type subfield set to 3. The NDP ACK frame may include a wakeup timer (like indicated by arrow 910) in the Duration field by setting the Duration Indication value to 1. The UL-Synch capable AP may protect the TXOP duration following the expiration of the wakeup timer. The STA may go to sleep (like indicated by sleep period 920) upon receiving the NDP ACK 908 frame and may wake up (like indicated by awake period 924) after the wakeup time expires. The STA may receive the Synch frame 912 from the AP and may start a data frame transmission (for example the STA may transmit a data frame 922, which may be acknowledged by AP with an NDP ACK frame 914).

FIG. 9B shows an illustration 926 of a PS-Poll frame transmission with Poll Type=3 according to various embodiments. Various portions of FIG. 9B are similar or identical to what is shown in FIG. 9A, so that the same reference signs may be used and duplicate description may be omitted. If the AP indicates, in its response to the PS-Poll frame 916, that there is more data (for example by sending an NDP ACK frame 928 with the More Data subfield is set to 1), after the sync frame 912, the AP may send a data frame 930 to the STA, which may be acknowledged by the STA with an NDP ACK frame 932. It is to be noted that in the NDP ACK frame 908 as shown in FIG. 9A, the More Data subfield is set to 0.

If a non-TIM STA (or a TIM STA) sends a NDP PS-Poll frame, the AP responds with either a buffered data frame or an NDP Modified ACK frame.

If a non-TIM STA (or a TIM STA) sends a trigger frame, the AP responds with either a buffered data frame or an (NDP) ACK frame.

The S1G AP may set More Data field to 1 in the responding control frame if there is BU (Buffered Unit) buffered for the non-TIM S1G STA. If the non-TIM S1G STA receives the responding control frame in which the Duration Indication field is equal to 1 and the Duration field is a nonzero value, there is no frame transmission for the STA in the indicated duration in which the S1G STA may go to sleep. After the amount of time that is equal to the value in the Duration field, it may be in the awake state.

An S1G AP may set the wakeup timer (Duration field) as the duration to a TBTT in the responding control frame (either NDP ACK or NDP Modified ACK frame) and treat the non-TIM STA as a TIM STA starting from the TBTT. After the amount of time that is equal to the Duration field value in the responding control frame from the S1G AP, the non-TIM S1G STA may wake up to receive the beacon. Upon receiving the beacon, the STA may infer from the TIM element that it is treated as a TIM STA and operates as a TIM STA from then on. The S1G STA may return to the non-TIM STA operation mode if the S1G AP indicates that there is no more data buffered for the S1G STA and the S1G STA indicates to the S1G AP that there is no more data to transmit. The S1G AP treats the S1G STA as a non-TIM STA if the STA indicates that there is no more data to transmit and the S1G AP indicates that there is no more data buffered for the STA.

An active polling STA is a STA that does not check the beacon for TIM information but it sends a PS-Poll frame to solicit the information from the AP.

A PS-Poll frame with Poll type set to 0 by an active polling STA solicits the buffered frame (status). A PS-Poll frame with Poll type set to 1 by an active polling STA solicits a TACK frame including the information of Change Sequence, (partial) timestamp and buffered frame status. A PS-Poll frame with Poll type set to 2 by an active polling STA that is a TWT STA solicits a TACK frame including the information of Change Sequence, (partial) timestamp, buffered frame status and Next TWT as described herein. A PS-Poll frame with Poll type set to 2 by an active polling STA that is not a TWT STA may solicit a NDP ACK frame that may contain the information of buffered frame status and wakeup timer (sleep duration). A PS-Poll frame with Poll type set to 3 by an active polling STA solicits a NDP ACK frame that may contain the information of buffered frame status and wakeup timer (sleep duration).

Upon waking up and without listening for a beacon, an active polling STA may solicit BSS change sequence and the current timestamp information from an AP by sending a polling message (PS-Poll). In this polling message, it may indicate whether the STA solicits the information of BSS change sequence and the current timestamp by setting the Poll Type subfield to 1. It can indicate whether the STA solicits the information of Next TWT or Duration to a TBTT by setting the Poll Type subfield to 2. In addition, a STA that has requested time slot protection for a TXOP duration after the expiration of a wakeup timer may transmit to the UL-Synch capable AP a PS-Poll frame with the Poll Type subfield in the Frame Control field set to 3.

In response to a PS-Poll frame with the Poll Type subfield set to 1 sent by an active polling STA, an AP may send a TACK frame in which the Next TWT Present field is set to 0 with the solicited information of BSS beacon sequence and partial timestamp to the STA immediately. In response to a PS-Poll frame with the Poll Type subfield set to 2, an AP may send to the STA that is not a TWT STA an NDP ACK frame that includes a Duration field which is a wakeup timer and set to the duration to a TBTT, which the STA uses to derive the transmission time of a beacon. In response to a PS-Poll frame with the Poll Type subfield set to 2, an AP may send to the STA that is a TWT STA a TACK frame in which the Next TWT field is set the next TWT of the TWT STA. The STA may listen to the beacon when the timer with the value as indicated by the Duration field of the NDP ACK frame expires or wake up the time equal to Next TWT of TACK is due. An UL-Synch capable AP may respond with an NDP ACK frame to a PS-Poll frame with the Poll Type subfield set to 3. The NDP ACK frame may include a wakeup timer in the Duration field by setting the Duration Indication value to 1. The UL-Synch capable AP may protect the TXOP duration following the expiration of the wakeup timer.

In the following, Listen Interval for TWT and non-TIM STA will be described.

The Listen Interval field is used to indicate to the AP how often a STA with dot11NonTIMModeActivated set to false (which means the STA operates in TIM mode) in power save mode wakes to listen to Beacon management frames or it is used to indicate to AP the duration during which a STA with dot11NonTIMModeActivated set to true (which means the STA operates in non-TIM mode) is required to transmit at least one PS-Poll or trigger frame.

The value of this parameter is the Listen Interval parameter and is expressed in units of Beacon Interval.

It may be desired to setup a rule that an AP may use the Listen Interval, DTIM interval and beacon interval information in determining the lifetime of frames that it buffers for a TIM STA if TIM segmentation is applied.

The Flow Type field may indicate the type of interaction between the TWT requesting STA and the TWT responding STA at a TWT.

A value of 0 in the Flow Type field may indicate an Announced TWT in which the TWT requesting STA will send a PS-Poll or a trigger frame to signal its awake state to the TWT responding STA before a frame is sent from the TWT responding STA to the TWT requesting STA.

A value of 1 in the Flow Type field may indicate an Unannounced TWT in which the TWT responding STA will send a frame to the TWT requesting STA at TWT without waiting to receive a PS-Poll or trigger frame from the TWT requesting STA.

As Flow Type 1 may allow TWT STA not to send PS-Poll/trigger frame at TWT but non-TIM STA is required to send PS-Poll/trigger frame once within Listen Interval. We need to resolve the confliction.

Listen Interval may be redefined as follows: The Listen Interval field may be used to indicate to AP the duration during which a STA with dot11NonTIMModeActivated set to true is required to transmit at least one PS-Poll or trigger frame, or the TWT responding AP STA may receive successfully at least once an acknowledgement (e.g. ACK) by the corresponding TWT requesting non-AP STA with Flow Type 1 in response to its frames transmitted to the TWT requesting non-AP STA, or if the TWT requesting non-AP STA with Flow Type 1 does not receive the frame, it may send a frame to the TWT responding AP STA.

If the TWT requesting non-AP. STA with Flow Type 1 does not receive the frame or TWT responding AP STA does not have frame transmitted to the corresponding TWT requesting non-AP STA, the TWT non-AP STA may send a frame to, receive an acknowledgement from the TWT requesting AP STA in the listen interval.

Alternatively, a rule may be setup that a TWT requesting STA with Flow Type 1 may at least transmit a PS-Poll/trigger frame to the corresponding TWT responding STA in Listen Interval
either through explicit indication in the frame addressed to TWT requesting non-AP STA from the corresponding TWT responding AP STA;
or implicit rule e.g. every some TWT intervals (<listen interval) or the last TWT closest to the end of current listen interval that TWT requesting non-AP STA may transmit PS-Poll/trigger frame before TWT responding AP STA transmitting any frame to itself.

The Listen Interval concept for non-TIM STA may be extended to the STA other than TWT STA.

The Listen Interval field may be used to indicate to AP the duration during which a STA with dot11NonTIMModeActivated set to true is required to transmit at least one PS-Poll or trigger frame, or the AP STA may receive successfully at least once an acknowledgement by the non-AP STA as the response to its frames transmitted to the non-AP STA, or if the non-AP STA doesn't receive the frame, it may send a frame to the AP STA.

The TWT responding NDP Paging STA may not be required to send PS-Poll/trigger frame, but it may schedule an NDP Paging frame as the first frame for transmission at the TWTs indicated by the NDP Paging Response, if any of the following conditions is satisfied:
There are BUs for the Requesting STA;
No NDP Paging frame was sent in the N consecutive preceding TWT(s), where N is equal to the value of the Max NDP Paging Period field in the NDP Paging Response.

Flow Type 1 allows TWT STA not to send PS-Poll/trigger frame in TWT SPs. For a duration equal to listen interval, there could be that only AP sends data frame to the TWT STA (expecting either No ACK or ACK) and it is not necessary that TWT STA shall send PS-Poll/trigger frame (e.g. no uplink frame). If ACK Policy of the transmitted frame is not No ACK, acknowledgement frame could be regarded as equivalent to PS-Poll/trigger frame. If ACK Policy of the transmitted frame is No ACK, TWT STA shall send a frame (PS-Poll/trigger frame/a frame soliciting next TWT) if no frame has been sent during listen interval.

The general idea may be that an acknowledgement by the non-TIM STA in the listen interval may be regarded as a frame equivalent to PS-Poll/trigger frame. Other frame than PS-Poll/trigger frame transmitted by non-TIM STA in the listen interval can be also regarded as a frame equivalent to PS-Poll/trigger frame. Usually such frame should be non NDP frame as NDP frame does not carry complete MAC address information.

The definition of Listen Interval can be redefined as follows: The Listen Interval field is used to indicate to AP the duration during which a STA with dot11NonTIMModeActivated set to true is required to transmit at least one frame that is individually addressed to the associated AP (PS-Poll frame, trigger frame, a frame sent by the TWT requesting non-AP STA (e.g. acknowledgment (response control frame) or a frame to solicit next TWT to the TWT responding AP STA, NDP Paging frame). The basic idea is to allow the frame transmitted by Non-TIM STA regarded as the same as PS-Poll/trigger frame.

While the invention has been particularly shown and described with reference to specific embodiments, it should be understood by those skilled in the art that various changes in form and detail may be made therein without departing from the spirit and scope of the invention as defined, by the appended claims. The scope of the invention is thus indicated by the appended claims and all changes which come within the meaning and range of equivalency of the claims are therefore intended to be embraced.

What is claimed is:

1. A communication method comprising:
at least one of sending a data unit or receiving a data unit;
wherein the data unit comprises a poll type field indicating one of a plurality of requests from a mobile radio communication device to an access point with respect to at least one of a transmission of buffered data from the access point to the mobile radio communication device or a timing of communication between the access point and the mobile radio communication device.

2. The communication method of claim 1,
wherein the data unit comprises a power save poll.

3. The communication method of claim 1,
wherein the plurality of requests comprises a request for a buffered frame without rescheduling of an awake/doze cycle.

4. The communication method of claim 1,
wherein the plurality of requests comprises a request for a buffered frame without a request to reschedule an awake/doze cycle.

5. The communication method of claim 1,
wherein the plurality of requests comprises a request for a change of a sequence and/or a timestamp information.

6. The communication method of claim 1,
wherein the plurality of requests comprises a request for a timing information.

7. The communication method of claim 6,
wherein the timing information comprises at least one of a duration to a TBTT or next TWT.

8. The communication method of claim 1,
wherein the plurality of requests comprises a request for a deferred service period to reschedule awake/doze cycle.

9. The communication method of claim 1,
wherein at least one of sending the data unit or receiving the data unit is sending the data unit from a mobile radio communication device to an access point.

10. The communication method of claim 9,
wherein the mobile radio communication device sleeps or awakes in accordance with the data unit the mobile radio communication device sends.

11. The communication method of claim 9,
wherein the mobile radio communication device sleeps or awakes in accordance with the received response to the data unit the mobile radio communication device sends.

12. The communication method of claim 1,
wherein at least one of sending the data unit or receiving the data unit is receiving the data unit in an access point from a mobile radio communication device.

13. The communication method of claim 12,
wherein the access point transmits buffered data to the mobile radio communication device in accordance with the data unit received by the access point.

14. A communication device comprising:
a data processing circuit configured to least one of send a data unit or receive a data unit;
wherein the data unit comprises a poll type field indicating one of a plurality of requests from a mobile radio communication device to an access point with respect to at least one of a transmission of buffered data from the access point to the mobile radio communication device or a timing of communication between the access point and the mobile radio communication device.

15. The communication device of claim 14,
wherein the data unit comprises a power save poll.

16. The communication device of claim 14,
wherein the plurality of requests comprises a request for a buffered frame without rescheduling of an awake/doze cycle.

17. The communication device of claim 14,
wherein the plurality of requests comprises a request for a buffered frame without a request to reschedule an awake/doze cycle.

18. The communication device of claim 14,
wherein the plurality of requests comprises a request for a change of a sequence and/or a timestamp information.

19. The communication device of claim 14,
wherein the plurality of requests comprises a request for a timing information.

20. The communication device of claim 19,
wherein the timing information comprises at least one of a duration to a TBTT or next TWT.

21. The communication device of claim 14,
wherein the plurality of requests comprises a request for a deferred service period to reschedule awake/doze cycle.

22. The communication device of claim 14,
wherein the communication device comprises a mobile radio communication device; and
wherein the data processing circuit of the radio communication device comprises a transmitter configured to send the data unit to an access point.

23. The communication device of claim 22,
wherein the mobile radio communication device is configured to sleep or awake in accordance with the data unit the mobile radio communication device sends.

24. The communication device of claim 22,
wherein the mobile radio communication device is configured to sleep or awake in accordance with the received response to the data unit the mobile radio communication device sends.

25. The communication device of claim 14,
wherein the communication device comprises an access point; and
wherein the data processing circuit of the access point comprises a receiver configured to receive the data unit in an access point from a mobile radio communication device.

26. The communication device of claim 25,
wherein the access point is configured to transmit buffered data to the mobile radio communication device in accordance with the data unit received by the access point.
